(19) United States
(12) Patent Application Publication
(10) Pub. No.: US 2021/0323325 A1
(43) Pub. Date: Oct. 21, 2021

(54) CUTTER MODULE AND METHOD

(71) Applicant: HEWLETT-PACKARD DEVELOPMENT COMPANY, L.P., Spring, TX (US)

(72) Inventors: Javier Garcia Blanco, Sant Cugat del Valles (ES); Jose Angel Garcia Femandez, Sant Cugat del Valles (ES); Xavier Adria Vales Abenoza, Sant Cugat del Valles (ES)

(21) Appl. No.: 16/498,523

(22) PCT Filed: Apr. 25, 2018
(86) PCT No.: PCT/US2018/029280

§ 371 Date: Sep. 27, 2019

(51) Int. Cl. B41J 11/68; B26D 7/26; B26D 5/02; B26D 1/24; B65H 35/06

(52) U.S. Cl. CPC B41J 11/68; B26D 7/2628; B26D 5/02; B65H 2301/51532; B65H 35/06; B65H 2301/51512; B26D 1/245

(57) ABSTRACT

A method includes placing a cutter module in an engaging position; moving a positioner associated with the cutter module away from a homing position to contact and drag the cutter module until it is detected that the cutter module hits a first obstacle; and aligning the cutter module with the positioner; wherein, in the engaging position, the cutter module is in the movement path of the positioner.

### BACKGROUND

Some printers include a cutting device which can cut a print medium before or after a printing operation. The cutting device may include a cutting blade supported on a carriage to move across a print zone. By movement of the carriage across the print zone and/or movement of the print medium along a media advance path through the print zone, the cutting blade may cut in one or two linear directions, such as the X and Y directions.

### BRIEF DESCRIPTION OF DRAWINGS

The following description references the drawings, wherein

FIG. 1 shows a perspective view of a cutting arrangement according to an example;

FIG. 2 shows a perspective view of the cutting arrangement of FIG. 1 in combination with printer parts according to an example;

FIG. 3 shows a perspective view of a part of the cutting arrangement including two cutter modules according to an example, with parts broken away;

FIG. 4 shows a different perspective view of the cutting arrangement and cutter modules shown in FIG. 3;

FIG. 5A shows a perspective view of a cutter module according to an example;

FIG. 5B shows a similar perspective view of a cutter module, according to an example, with parts broken away;

FIG. 6A shows a perspective view of a left hand positioner of a cutter module according to an example;

FIG. 6B shows a perspective view of a right hand positioner of a cutter module according to an example;

FIG. 7 shows a perspective view of a cutter arrangement with a cutter module in a disengaged position, according to an example;

FIG. 8 shows a perspective view of a cutter arrangement with a cutter module in an engaged position, according to an example;

FIG. 9 shows a perspective view of part of a cutter arrangement with a cutter module in an engaging position, according to an example;

FIG. 10 shows a flow diagram illustrating an example of a homing process;

FIG. 11 shows a flow diagram illustrating another example of a homing process;

FIG. 12 shows a flow diagram illustrating part of a homing process according to an example;

FIG. 13 shows a flow diagram illustrating another part of a homing process according to an example.

### DETAILED DESCRIPTION

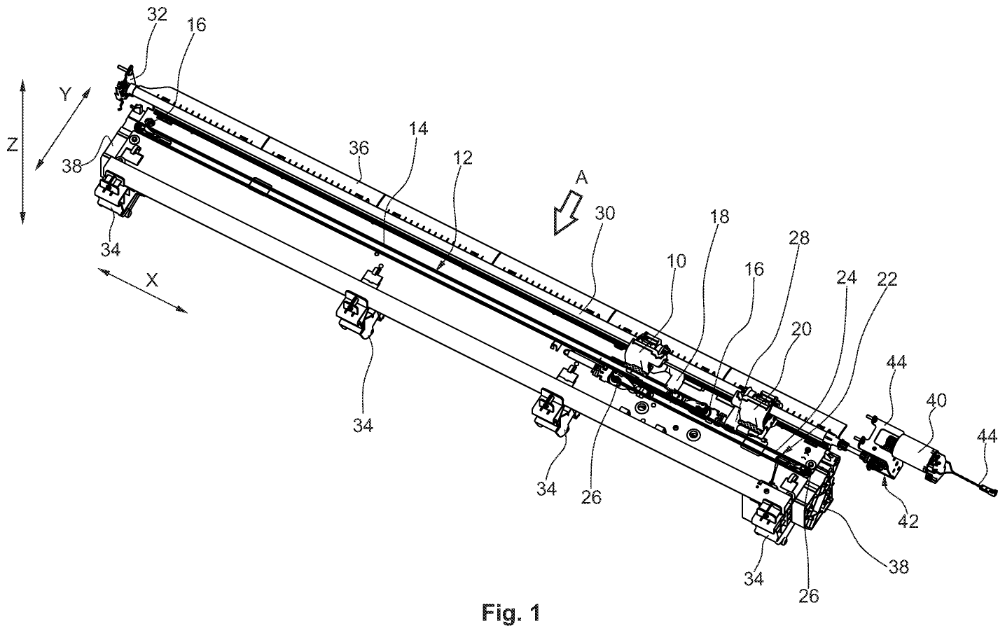

FIGS. 1 to 4 provide an overview to illustrate a cutting arrangement using two cutter modules according to an example, in different perspective views.

In the illustrated example, the cutting arrangement comprises a first cutter module 10 and a second cutter module 20, which are discussed in further detail below. The first and second cutter modules 10, 20 are arranged on a shaft 30 extending in a direction perpendicular to a media advance direction of a printer which is illustrated by arrow A. The media advance direction A also is referred to as Y direction, and a carriage scanning direction, perpendicular to the Y direction, also is referred to as X direction. The direction of gravity, perpendicular to both the Y and X directions, may be designated as Z direction. The first cutter module 10 also can be designated as left-hand cutter module, and the second cutter module 20 also can be designated as right-hand cutter module, wherein left and right designates the position of the cutter module as seen from the front of the printer which, in this example, is the direction opposite to the media advance direction A.

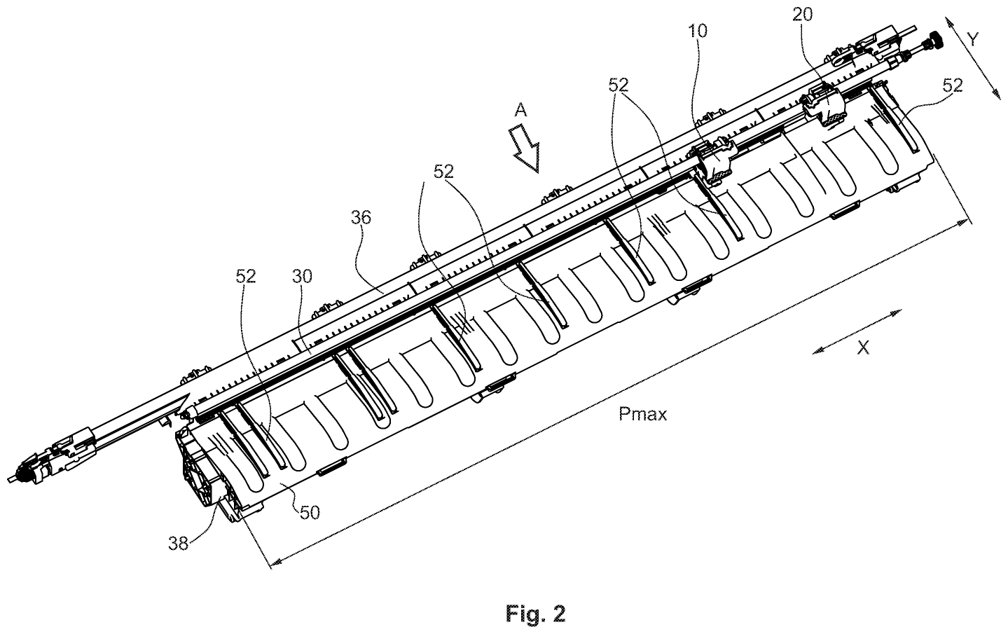

The two cutter modules 10, 20 are arranged on the shaft 30 to be independently slidable along the length of the shaft 30, e.g., along the scanning direction, wherein sliding movement of the cutter modules 10, 20 can be caused by respective first and second pulley drives 12, 22 coupled to the first and second cutter modules 10, 20 via positioners 18, 28. This allows selectively positioning the two cutter modules 10, 20 at a right-hand edge and a left-hand edge of a cutting zone downstream of a print zone of the printer, for different cutting zones of varying width and position. In the illustrated example, a cutting zone of maximum width Pmax would extend about across the width of an output platen 50, illustrated in FIG. 2. Each pulley drive 12, 22 comprises a pulley belt 14, 24 and pulley wheels 16, 26 and drive units (not shown) for driving at least one of the pulley wheels 16, 26 of each pulley drive. A drive unit may comprise e.g. an electric motor.

In the illustrated example, pulley drive 22 associated with the second or right-hand cutter module 20 extends across about 30% of the maximum cutting zone width Pmax, at the right-hand side of the cutting zone, and pulley drive 12 associated with the first or left-hand cutter module 10 extends across about 80-90% of the maximum cutting zone width Pmax, at the left-hand side of the cutting zone. The belts 14, 24 of the first and second pulley drives 12, 22 overlap and, for example, can be designed in such a way that the first and second cutter modules 10, 20 can be positioned at any left-hand and right-hand margins of a print medium which the associate printer is able to print on in the print zone.

The first and second cutter modules 10, 20 are removably coupled to the first and second pulley belts 12, 24 by respective positioners 18, 28 to be engaged with the cutter modules 10, 20. Accordingly, movement of either one of the belts 14, 24 pulls the associated cutter module 10, 20 along the shaft 3o to position the cutter modules 10, 20 on two sides of an adjustable cutting zone, for example.

The shaft 30 is coupled to a drive motor 40 via a drive gear train 42, including a number of gears, for transmitting rotation of the drive motor 40 to the shaft 30. The drive motor 40 may be a servomotor, a BLDC motor or a stepping motor or another electric motor. The drive motor 40 may be supplied and driven via supply/drive lines 44 operatively coupled to a controller (not shown) of the printer, for example.

The cutter arrangement including the drive motor 40 may be mounted in a printer chassis (not shown) via a number of brackets and supports 32, 34, 36, 38, 44.

FIG. 2 illustrates an output platen 50 which may serve as support for a print medium which is transported through the printer and out of a print zone in the media advance direction A. the output platen 50 covers the pulley drives 12, 22 and the positioners 18, 28 to guide the print medium on a smooth surface of the output platen 50. The cutter modules 10, 20 will be arranged above the output platen. FIG. 2 further shows a number of retractable ribs 52 which are provided for supporting the print medium to stay flat and even when transported in the media advance direction A. A print media advance system (not shown) may be provided to transport the print medium through the print zone and across the output platen 50 in a media advance direction A. Further, a print head (not shown) may be arranged above the print zone upstream of the output platen 50 to deposit a printing fluid on the print medium within the print zone. The print head or several print heads may be carried by a printer carriage which may be slidable along a bar or a shaft (not shown) parallel to shaft 30 and extending in a direction perpendicular to the media advance direction A. The carriage may carry an array of print heads containing printing fluids, e.g. four, MCYK, ink inkjet print heads. The printing fluid may be dispensed from the print heads which may be any fluid that can be dispensed by an inkjet-type printer or other inkjet-type dispenser and may include inks, varnishes, and/or post or pre-treatment agents, for example. The carriage scans across the print medium in the print zone while the print heads are selectively fired to generate a printed plot.

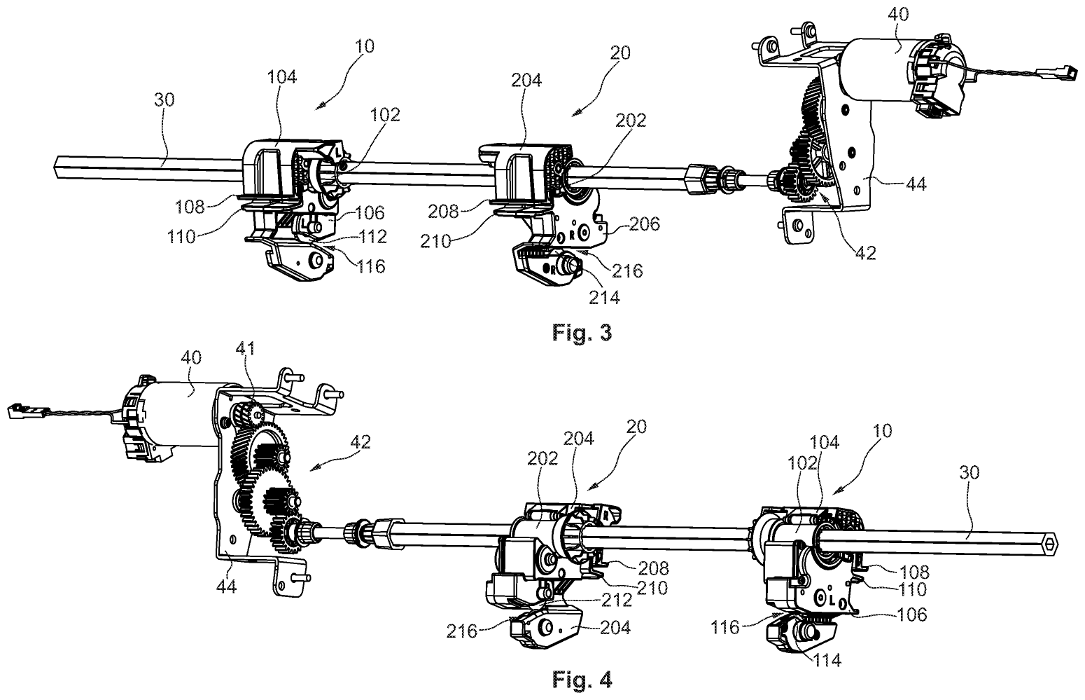

FIGS. 3 and 4 show further details of the drive gear train 42, coupling the drive motor 40 to the shaft 30, and of the coupling mechanism between the drive shaft 30 and the first and second cutter modules 10, 20. FIG. 3 is a perspective view from a similar angle as FIG. 1, and FIG. 4 is a perspective view from the opposite side of FIG. 3. The same or corresponding components as in the previous figures are designated by the same reference numbers.

In the illustrated example, the drive gear train 42 comprises a number of spur gears which, in the example, provide three transmission stages to transmit rotation of a toothed output shaft 41 of the drive motor 40 to shaft 30. The drive gear train 42 allows adjusting the rotation speed of the shaft 30 and transmits rotation of output shaft 41 in both a clockwise direction and a counterclockwise direction.

In the illustrated example, the shaft 30 has a polygonal cross-section, such as a hexagonal cross-section wherein other cross-sections, including a circular or noncircular, elliptic or a non-symmetrically shaped cross-section may be provided. The cutter modules 10, 20 are coupled to the shaft 30 by respective transmission rings 102, 202. In the example, the transmission rings 102, 202 engage with the outer periphery of the shaft 30 in a formfitting manner wherein, alternatively or additionally, a press fit or engagement by additional fixing elements, such as a screw, a bracket, adhesive or the like may be provided.

In the illustrated example, each cutter module 10, 20 comprises an upper module half 104, 204 and a lower module half 106, 206 which clamp the respective transmission ring 102, 202. Handle-like extensions 108, 110, 208, 210 are provided at the upper and lower module halves 104, 204 to be grabbed and pressed against each other to pivot the upper and lower module halves 108, 110, 208, 210 relative to each other to disengage the module halves from the transmission rings and unlatch the respective cutter modules 10, 20 from the transmission rings 102, 202. Accordingly, each cutter module 10, 20 can be replaced by pressing together the-handle-like extensions 108, 110, 208, 210, unlatching the cutter modules 10, 20 from the transmission rings 102, 202 and inserting another cutter module by the reverse operation.

In the example illustrated, each of the cutter modules 10, 20 comprises an upper rotary cutting blade 112, 212 and a lower rotary cutting blade 114, 214, which may be better recognized in the following drawings. The upper rotary cutting blade 112, 212 is an example of an active cutting blade and the lower rotary cutting blade 114, 214 is an example of a passive cutting blade. The respective upper rotary cutting blades 112, 212 are movable cutting blades which are driven to rotate by rotation of the shaft 30, via a respective transmission group provided in the respective cutter module 10, 20. Each transmission group may have an adjustable transmission ratio. In the example, the lower rotary cutting blade 114, 214 may be in contact with the upper rotary cutting blade 112, 212 to be friction-driven by the upper rotary cutting blade and to cut a print medium there between. In another example, instead of providing a lower rotary cutting blade, a lower stationery blade may be provided, such as a knife like linear blade, which interacts with the upper rotary cutting blade 112, 212 to cut a print medium there between. The lower stationery blade is another example of a passive cutting blade. In another example, the upper rotary cutting blade 112, 212 may interact with a counter surface, instead of a lower cutting blade, to cut the print medium transported across the counter surface.

In the examples, each of the cutter modules 10, 20 comprises a gap 116, 216 to guide a print medium there between and towards the associated cutting blades 112, 114, 212, 214.

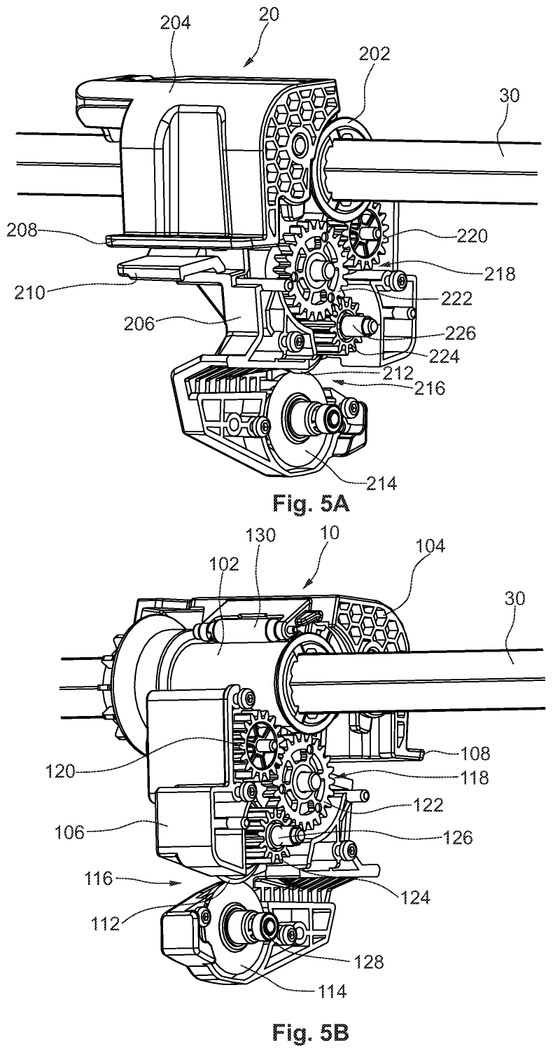

FIGS. 5A and 5B show two different perspective views, from opposite sides, of a right-hand cutter module 20 and a left-hand cutter module 10, with parts broken away to illustrate the transmission group 118, 218 between the shaft 30 and the upper rotary blade 112, 212, according to an example. The same or corresponding components as in the previous drawings are designated by the same reference numbers. Reference is made to the above description of FIGS. 1 to 4. A first gear 120, 220 comprises a cylindrical body which engages with the surface of the transmission ring 102, 202 to transmit rotation of the shaft 30 and the transmission ring 102, 202 to first gear 120, 220. The first gear 120, 220 meshes with a second gear 122, 222 which, in turn, meshes with a third gear 124, 224. The third gear 124, 224 is supported on a common rotary shaft 126, 226 which also carries the upper rotary blade 112, 212. Accordingly, rotation of the shaft 30 is transmitted to the upper rotary blade 112, 212 by the transmission ring 102, 202 and the gear train 118, 218. The first, second, and third gears 120, 122, 124; 220, 222, 224 can be designed to achieve a desired transmission ratio. By controlling the rotation speed of the shaft 30 and adjusting the transmission ratio, the upper rotary blade 212 can be rotated at a plurality of desired discrete rotation speeds or over a range of rotation speeds so as to cut print media at varying speeds. For example, the circumferential speed of the upper rotary blade 112, 212 can be the same as or higher than the speed at which the print medium is transported in the media advance direction A. Moreover, the rotation speed of the upper rotary blade can be adjusted according to the type of print medium, such as the thickness and/or rigidity of the print medium. For example, for a thicker and/or harder print medium a higher cutting speed may be selected then for a thinner and/or softer print medium.

In the illustrated example, the lower rotary blade 114, 214 is supported by an associated rotary shaft 128, 228 supported in the lower module half 106, 206. The lower rotary blade 114, 214 may be driven by the upper rotary blade 112, 212 by friction contact between the two blades 112, 114; 212, 214. Rotary shafts 126, 128; 226, 228 as well as respective shafts of the first and second gears 120, 122; 220, 222 may be supported in the upper and lower module halves 104, 106; 204, 206 in respective bearings, not separately described. FIG. 5B further illustrates a pinch roller 130 engaging the upper module half 104 with the transmission ring 102 in a low friction engagement.

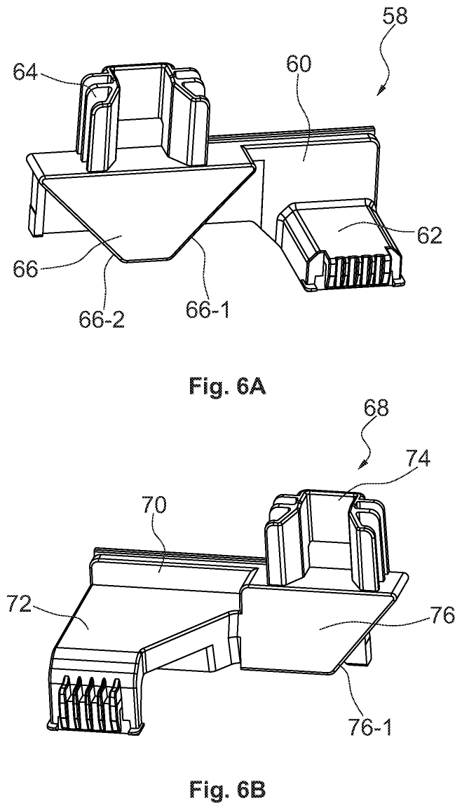

The gear train 118, 218 is designed to rotate in one direction and to block rotation in the other direction. In the example shown, based on the perspective view of FIG. 5A, if the shaft 30 rotates in the counterclockwise direction, rotation will be transmitted by the transmission group 218 and the third gear 224 and hence the upper rotary blade 212 will be driven to rotate in the clockwise direction to cut a print medium which enters the gap 216. If, however, the shaft 30 rotates in the clockwise direction, the gear train 218 will lock and rotation of the shaft 30 will pivot the entire cutter module 20 from a cutting position shown in FIGS. 3 and 4 into a tilted or disengaging position, shown in FIG. 6, where the cutter module is moved out of the plane of print platen and retractable ribs. The cutter module 20 and the cutter module 10 may be pivoted around the shaft 30 e.g. in a range of 45° to 180° from the cutting position shown in the drawings to the disengaged position which may be a standby position. To this end, one of the first, second, and third gears 120, 122, 124; 220, 222, 224 can be implemented as a locking gear interacting with a ratchet pawl which allows rotation in one direction but not in the other direction.

FIGS. 6A and 6B show perspective views of a left hand positioner 58 and a right hand positioner 68 according to some examples. The left hand positioner 58 is a positioner associated with a left hand cutter module, such as cutter module 10, and is to be engaged with the left hand cutter module. The right hand positioner 68 is a positioner associated with a right hand cutter module, such as cutter module 20, and is to be engaged with the right hand cutter module. Each positioner comprises a body 60, 70 carrying an arm 62, 72 for engagement with the associated pulley drive 12, 22. Arm 62 engages with pulley belt 14, and arm 72 engages with pulley belt 24. Further, each positioner comprises a mount 64, 74 for engagement with the respective cutter module 10, 12, and an engaging element 66, 76 having at least one inclined guide surface 66-1, 66-2, 76-1 which may interact with retractable ribs 52, as described below. The mount 64, 74 may comprise a funnel shape structure or similar structure into which a part of the cutter module may be inserted for engagement and disengagement therewith. The mount 64, 74 may be considered a first engaging element. The inclined guide surfaces 66-1, 66-2. 76-1 may form a second engaging element of the respective positioner.

As the arm 62, 72 is engaged with the pulley drive 12, 22, the positioner 58, 68 can be moved in the scanning direction or X direction to drag the associated cutter module 10 or 20, if engaged with the positioner 58, 68, along the shaft 30. The left hand positioner 58 can be moved across a distance spanned by the left-hand pulley drive 12, and the right and positioner 68 can be moved across a distance spanned by the right-hand pulley drive 22.

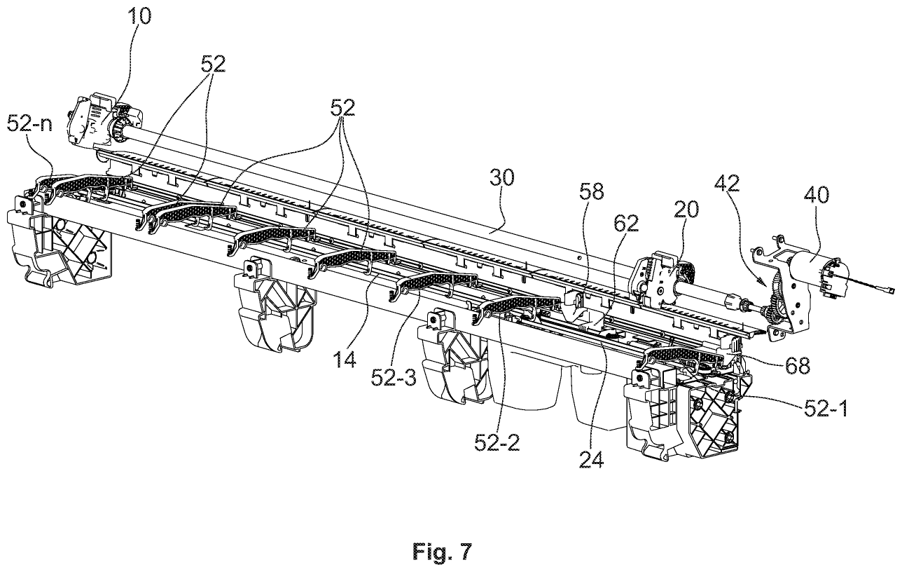

FIG. 7 illustrates a cutter arrangement in a printer, with parts broken away. The same or similar parts as in the previous drawings are designated by the same reference numbers. Not all of the details are reiterated and reference is made to the description of FIGS. 1 to 6, above. FIG. 7 shows a left hand cutter module 10 and a right hand cutter module 20, both in a disengaged position, in which they are raised above the plane of the platen (not shown) and the retractable ribs 52, by rotation of the shaft 30, as explained above. The left hand cutter module 10 and the right hand cutter module 20 may be located at an arbitrary positions along the length of the shaft 30, such as to the very right and to the very left of a maximum width print zone or at any other position where they may have been left after completing a previous cutting operation. The right hand positioner 68 of the right hand cutter module 20 is shown at the very right-hand edge of the print zone and is engaged with the pulley belt 24 via its arm (not clearly recognizable in FIG. 7). Further, the left-hand positioner 58 is shown to be engaged with the left-hand pulley belt 14 via its arm 62. The cutter module 20 and the positioner 68 are not engaged and not aligned. FIG. 7 may reflect an initial situation, e.g. after a printer start or reset or after a printer cover has been opened to replace a cutter module and then closed again, in which the positions of the cutter modules 10, 20 and associated positioners 58, 68 are unknown, both absolute positions and their positions relative to each other. FIG. 7 further illustrates the retractable ribs 52 which are in the drawing designated as 52-1, 52-2, 52-3, from right to left, wherein the most left-hand retractable rib is designated as 52-n.

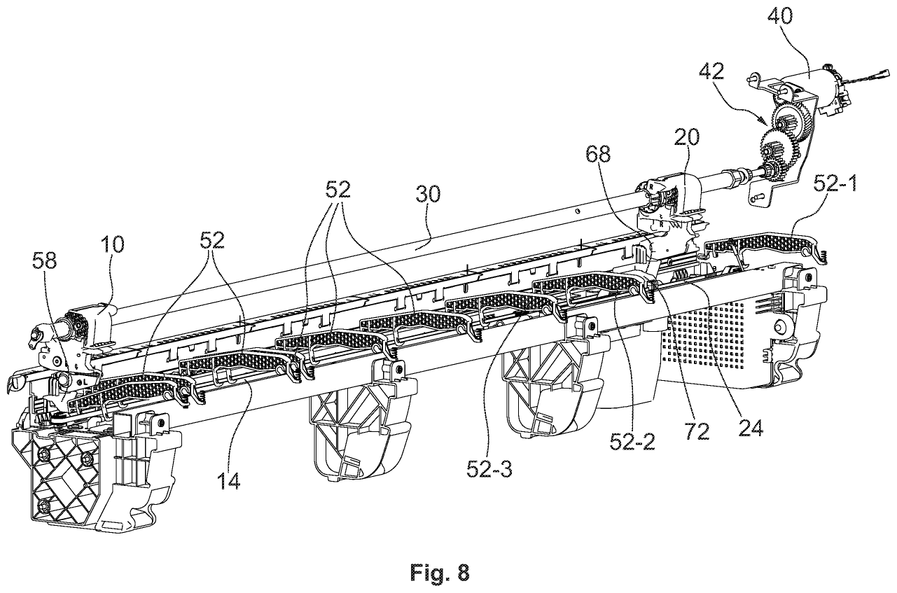

FIG. 8 illustrates another view of the cutter arrangement in a printer, with parts broken away. The same or similar parts as in the previous drawings are designated by the same reference numbers. Not all of the details are reiterated and reference is made to the description of FIGS. 1 to 7, above. FIG. 8 shows a situation in which the left-hand cutter module 10 and the right hand cutter module 20 are engaged with the respective positioners 58 and 68, respectively. The cutter modules 10, 20 can be transferred between their disengaging and engaging position by raising and lowering the cutter modules by rotation of the shaft 30, as explained above. The cutter modules 10, 20 are engaged with their respective positioners 58, 68 by inserting part of the cutter modules 10, 20 into the respective mount 64, 74.

The engaging and disengaging positions of the cutter modules refer to positions in which the cutter modules are respectively lowered and raised. In the engaging position, the cutter modules generally are in a position where they would be able to perform a cutting position. Accordingly, moving the cutter module to the disengaging position comprises an upwards movement and moving the cutter module to an engaging position comprises a downwards movement. In the examples illustrated, a cutter module is engaged with the associated positioner if part of the cutter module is inserted into and held by the respective mount of the positioner. In an engaged position, a cutter module is aligned with its respective positioner and lowered so that it is inserted into the respective mount. Accordingly, an engaging position not necessarily is a position in which the cutter module and its associated positioner are engaged.

The positioner 58 of the left hand cutter module 10 is engaged with the pulley belt 14 via its arm 62, and the positioner 68 of the right hand cutter module 20 is engaged with the pulley belt 24 via its arm 72. The cutter modules 10, 20 and the positioners 58, 68 are engaged so that the positioners 58, 68 can drag the cutter modules 10, 20 in the scanning direction X, bidirectionally, along the shaft 30 to position the cutter modules at desired cutting positions. FIG. 8 may reflect a situation which occurs during or after a homing process, as explained below.

FIG. 8 also illustrates how one of the retractable ribs 52, in the drawing the most left-hand rib 52-n, is engaged with one of the inclined surfaces 66-2 of the second engaging element 66 of the positioner 58 to push down the associated end of the retractable ribs 52 so that the positioner can guide the cutting module 10 over the retractable rib 52-n.

The retractable ribs 52 are support elements to support a print medium, wherein the retractable ribs 52 cooperate to support the printable medium and are independently movable between respective protruding and retracted positions by individually engaging protruding portions of the retractable ribs by the inclined surfaces 66-1, 66-2, 76-1 of the second engaging element 66, 76 of the respective positioners 58, 68. The retractable ribs 52 may comprise elastic elements to bias the ribs 52 towards the protruding position. The print medium may be supported by the retractable ribs 52 while being cut by cutter modules 10, 20 and while being printed on.

The retractable ribs 52 of the print medium support may provide continuous guidance for the print medium through the printer. However, the retractable ribs may also obstruct the movement of the cutter modules 10, 20, which are movable in a direction perpendicular to the media advance direction, i.e. along the shaft 30, to adjust the width of the plot. To be able to move the cutter modules 10, 20, using the positioners 58, 68, and thereby adjust the width of the plot of the print medium, the inclined surfaces 66-1, 66-2, 76-1 of the positioners 58, 68 may engage with protruding portions of the ribs 52 and thereby push down and move the retractable ribs to the retracted position. When in the ribs 52 are in the retracted position, the positioners 58, 68 can move over the ribs 52. If a respective cutter module 10, 20 is engaged with its positioner 58, 68, it will be able to move over the ribs 52, together with the positioner.

In the examples shown in FIGS. 6A and 6B, the left-hand positioner 58 comprises two inclined surfaces 66-1 and 66-2 whereas the right hand positioner 68 comprises one inclined surface 76-1. The reason is that, in this specific example, the right hand positioner 68 has a limited movement range, defined by the movement range of the right-hand pulley drive 22, which is located to the right of the rib 52-2 which is the next neighbor to the most right hand rib 52-1. Accordingly, the right hand positioner 68 will not have to travel from right to left across either one of the ribs 52-2, 52-3, . . . , 52-n illustrated in FIGS. 7 and 8. The left-hand positioner 58, on the other hand, has a movement range defined by the movement range of the left-hand pulley drive 12 and travels across all of the retractable ribs 52-2, 52-3, . . . , 52-n, except for the most right hand rib 52-1. Accordingly, the left-hand positioner 58 is designed to travel across the retractable ribs 52 from left to right and from right to left, respectively engaging the ribs with its two inclined surfaces 66-1 and 66-2 to push down the respective ribs. The designs of the positioners 58, 68 and the respective second engagement elements 66, 76 is specific to the examples shown and is not limited by these examples. Rather, the concept of the interaction between the second engaging elements 66, 76 and the retractable ribs 52 can be extended to other types of engaging elements and movable obstacles.

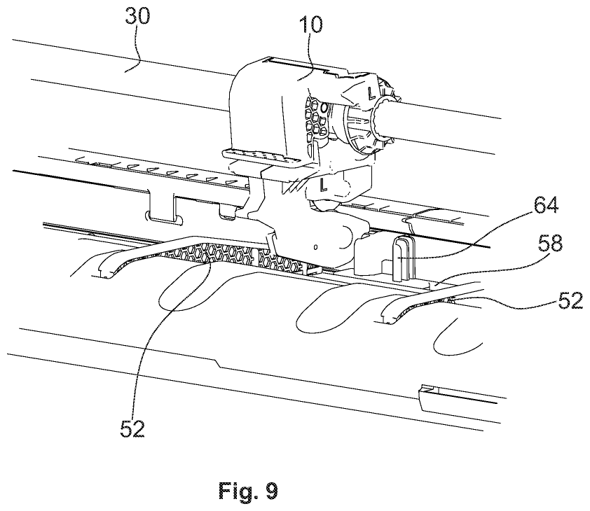

FIG. 9 illustrates a part of the cutter arrangement according to another scenario in which the left-hand cutter module 10 is in the lowered engaging position but is not engaged with the associated left-hand positioner 58, i.e. it is not inserted in the mount 64 of the left-hand positioner 58. In the example of FIG. 9, the left-hand cutter module 10 is located to the left of the positioner 58 and rests against an outer face of the mount 64. If, in this scenario, the positioner 58 is moved from right to left, it will drag the left-hand cutter module 10 to the left-hand side until the cutter module 10 hits one of the retractable ribs 52 which obstructs the movement path of the cutter module 10. Because the cutter module 10 is not engaged with the positioner 58, but is upstream of the positioner 58, the positioner 58 will not engage the retractable rib 52 and will not push down the retractable rib 52 before the cutter module 10 reaches the rib 52. Accordingly, the cutter module 10 may crash into the rib 52 which hence is an obstacle to the movement path of the cutter module 10.

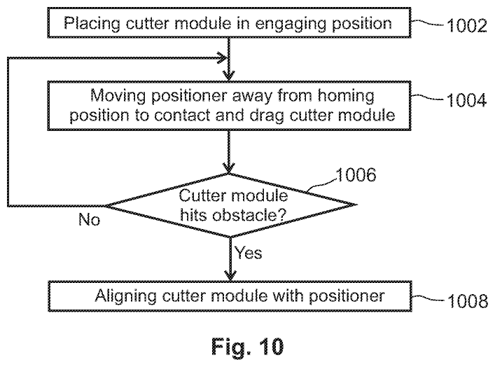

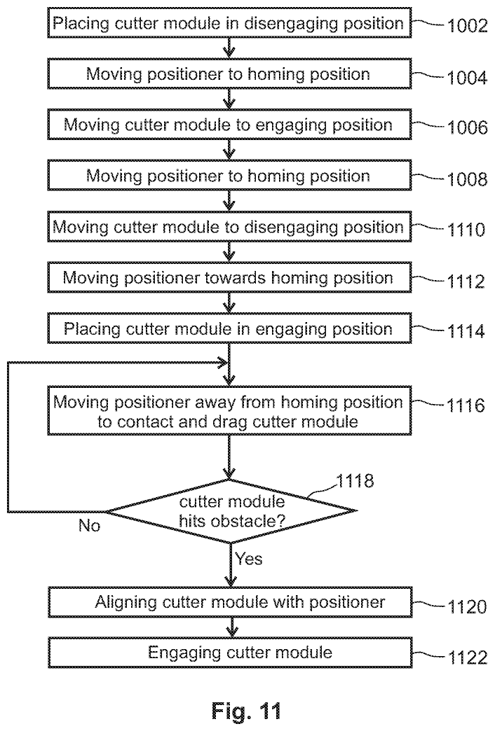

For calibrating the positions of the cutter modules, the respective positioners and cutter modules can go through a homing process. At the beginning of the homing process, the system may not know the absolute and relative positions of the cutter modules 10, 20 and the positioners 58, 68, and it also may not know whether the cutter modules are engaged with the positioners or not. FIG. 10 shows a flow diagram illustrating an example of a homing process.

The homing process is used to find the cutter modules 10, 20 at their current position along the shaft 30 and to move the cutter modules to a homing position or zero position to have a defined reference point for positioning the cutter modules at desired cutting position. This helps achieving good accuracy in positioning the cutter modules. The homing process may be run automatically after a printer is turned on, after a printer reset, after a replacement or other manipulation of a cutter module, at defined time intervals and/or after a printer cover has been opened and closed, for example. Opening and closing of a printer cover may be an indication that a user has moved or has removed and replaced a cutter module. In such a situation, the printer does not know whether the cutter modules have been moved from their previous position or even replaced. The printer also does not know whether the cutter modules are engaged or aligned with the positioners or not. The homing process may detect such external changes to the printer.

Whereas it would be possible to provide the printer with sensors for detecting that a cutter module is engaged with its associated positioner and/or for detecting the position of the cutter module along the length of the shaft, because the positioners and the cutter modules are movable along the length of the shaft, this would require sensors and flexible cabling of sensors which may be undesirable. The homing process according to the examples described herein can ensure that the cutter module is aligned and/or engaged with its associated positioner and that the position of the cutter module is known, without or essentially without the use of sensors.

The example of the homing process shown in FIG. 10 is described in the following with reference to the right hand cutter module 20 and its associated positioner 68. It may be applied to the left hand cutter module 10 and its associated positioner 58 in an analogous way.

In the example of a homing process shown in FIG. 10, the homing process may begin at an initial situation in which a positioner is at or close to its homing position and an associated cutter module is not engaged with the positioner. Such situation may be detectable by a sensor located at or close to the homing position. The cutter module is placed in the engaging position, at 1002, wherein, in the engaging position, the cutter module is in the movement path of the positioners. For example, cutter module 10 is placed in its engaging position, as shown in FIG. 9. As explained above, in the engaging position, the cutter module is tilted downwards to its cutting position but not necessarily engaged with the associated positioner. The cutter module will be engaged with its associated positioner if in the engaging position and aligned with the positioner. If not aligned, it will be in the “engaging position” but not engaged with the positioner.

The positioner associated with the cutter module then can be moved away from the homing position, in examples shown in FIG. 7 to 9 from right to left, to contact the cutter module and, with continued movement away from the homing position, drag the cutter module to the left, at 1004, until it is detected that the cutter module hits a first obstacle, at 1006. As long as it is not detected that the cutter module hits an obstacle, movement of the positioner and hence the cutter module away from the homing position and to the left continues. FIG. 9 shows an example of a situation where the cutter module 10 is in its engaging position but not engaged with the associated positioner 58. When the positioner 58 is moved to the left, away from its homing position, it drags the cutter module 10 until the cutter module hits an obstacle. In this example, the obstacle is a protruding retractable rib 52. In other examples, the obstacle may be a protrusion arranged along the length of the shaft or an end stop arranged at the distal end of the shaft or at an edge of the print zone, for example.

At 1006, the printer may detect that an obstacle has been hit because, in this situation, the positioner cannot continue its movement and a torque of the drive system, such as the drive motor 40 will increase. By monitoring the motor voltage, motor current or motor torque, for example, an increase in the motor torque can be detected and used as a feedback signal indicating that the cutter module, which is dragged by its associated positioner, has hit an obstacle and hence has come to a stop. In this situation, the printer knows that the cutter module is not engaged with the positioner, because the retractable rib 52 would not be an obstacle to the positioner, as explained above. The printer further knows the relative position of the cutter module and its associated positioner because the cutter module will rest against the outer face of the mount 64 while being dragged by the positioner 58.

If the positioner travels over the entire length of the shaft 30 without hitting an obstacle, this may be an indication that a cutter module is missing. A respective message can be signaled to a user, such as on a display (not shown) of the printer.

In some examples, the cutter modules are supported on the shaft by low friction transmission rings 102, 202 so that the positioners can drag the cutter modules along the shaft 30 without or without noticeable resistance. Accordingly, when the positioner contacts and moves the cutter module, there may be no noticeable increase of torque so that this scenario cannot be detected by a respective feedback signal from the drive motor. However, if an obstacle is hit, a noticeable increase in torque of the drive motor 40 will be generated. Accordingly, the homing process can use different types of obstacles in the path of the cutter modules as reference points for detecting that the positioner has made contact with its associated cutter module.

Once the relative position of the cutter module and its associated positioner are known, the cutter module can be aligned with the positioner, at 1008, e.g. by inserting part of the lower module half into the mount 64. The funnel shape of the mount 64 allows compensating for tolerances of different cutter modules or slight offsets. The inclined interior sides of the mount 64 guide the cutter module to be centered in the mount. In a variant, engaging and disengaging the positioner 68 and the cutter module 20 can be repeated a few times, such as 3 times, to ensure that the cutter module 20 is reliably engaged with the positioner 68. Accordingly, the system now knows that the cutter module is aligned with its associated positioner and the cutter module can be engaged with the positioner to move the cutter module to a homing position, reference position or a cutting position. The cutter module also can remain at the now known position until needed for a subsequent cutting operation.

A more detailed example of a homing process is described with reference to FIG. 11. In the example of a homing process shown in FIG. 11, the homing process may start from an initial situation in which neither the position of the cutter module nor the position of its associated positioner is known. Further, it is unknown whether the cutter module is engaged with its associated positioner. The example of the homing process shown in FIG. 11 may be performed without the use of sensors. The example of the homing process shown in FIG. 11 is described below with reference to the right hand cutter module 20 and its associated positioner 68. It may be applied to the left hand cutter module 10 and its associated positioner 58 in an analogous way.

The homing process may begin at 1102 with placing a cutter module 20 in a disengaging position, such as shown in FIG. 7, wherein, in the disengaging position, the cutter module is clear of the movement path of the positioners. Movement of the cutter module to the disengaging position may comprise an upwards movement of the cutter module, as explained above. At 1104, the associated positioner 68 is moved to a homing position or zero position which, in this example, is the most right hand position of the positioner 68, as shown in FIG. 7. At 1106, the cutter module 20 is moved downwards to its engaging position wherein, in this situation, the printer does not know whether the cutter module 20 had been aligned with its associated positioner 68 or not. If the cutter module 20 had been located at the homing position and hence had been aligned with the positioner 68 which, at 1104, is moved to the homing position, the cutter module 20 and the positioner 68 now will be engaged. If the cutter module 20 had not been located at the homing position, it will now be in the engaging position but not engaged with the positioner 68.

At 1108, the positioner 68 is moved away from the homing position by a defined distance which, in this example, is a movement along the horizontal scanning direction to the left. If, in this situation, the cutter module 20 is engaged with the positioner 68, it will follow the movement of the positioner 68. At 1110, the cutter module is moved upwards to its disengaging position; and at 1112, the positioner is moved back, to the right, towards its homing position. This sequence of steps results in a defined relative position of the cutter module 20 and the positioner 68 in which the cutter module 20 is not engaged and not aligned with the positioner 68 but is located at least the defined distance away from the homing position and to the left of the positioner 68.

This scenario corresponds to the initial situation of the homing process described in the example of FIG. 10. The further sequence in the homing process, illustrated at 1114, 1116, 1118 and 1120 may correspond to the sequence of the homing process of FIG. 10, illustrated at 1002, 1004, 1006 and 1008. Reference is made to the above description of FIG. 10. At the end of 1120, the printer knows that the cutter module 20 is aligned with its associated positioner 68 and further knows where the cutter module is located. The cutter module 20 then can be engaged with the positioner 68, at 1122, and the engaged cutter module 20 can be moved to a homing position, reference position or cutting position. The cutter module also may rest where it is, in the disengaging position, and may be picked up later for use in a cutting operation.

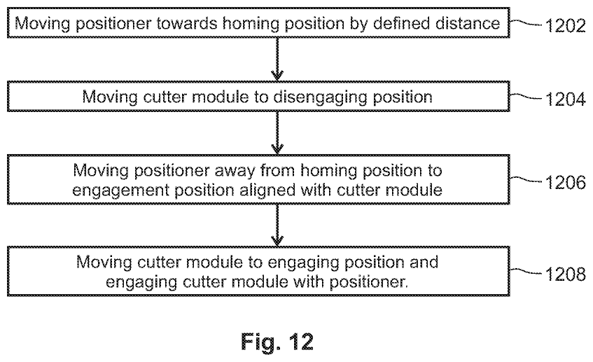

FIG. 12 shows a flow diagram illustrating a part of the homing process used to engage the cutter module with the positioner after detecting that the cutter module has hit the obstacle, according to an example. Also this example is described with reference to the right hand cutter module 20 and the associated positioner 68 wherein the homing position is located at the right of the print zone and the movement of the positioner 6o away from the homing position and towards the obstacle is from right to left. It may be applied to the left hand cutter module 10 and its associated positioner 58 in an analogous way.

The sequence of FIG. 12 starts from a situation in which it has been detected that the cutter module 20 has hit an obstacle, such as by detecting an increase of the torque of the drive motor. In this situation, the printer knows that the cutter module 20 is not engaged with its associated positioner 68 and further knows that the cutter module 20 rests against an outer face of the positioner 68. Accordingly, the relative positions of the cutter module 20 and the associated positioner 68 are known. At 1202, the positioner 68 is moved away from the obstacle towards its homing position by a defined distance so that the obstacle, the cutter module and the positioner are out of contact to remove any bias from the system. At 1204, the cutter module 20 then can be moved upwards to the disengaging position; and at 1206, the positioner 68 can be moved away from the homing position towards an alignment position where it is located under and aligned with the cutter module 20. At 1208, the cutter module 20 may be moved downwards to the engaging position where it is engaged with the mount 74 of the positioner 68.

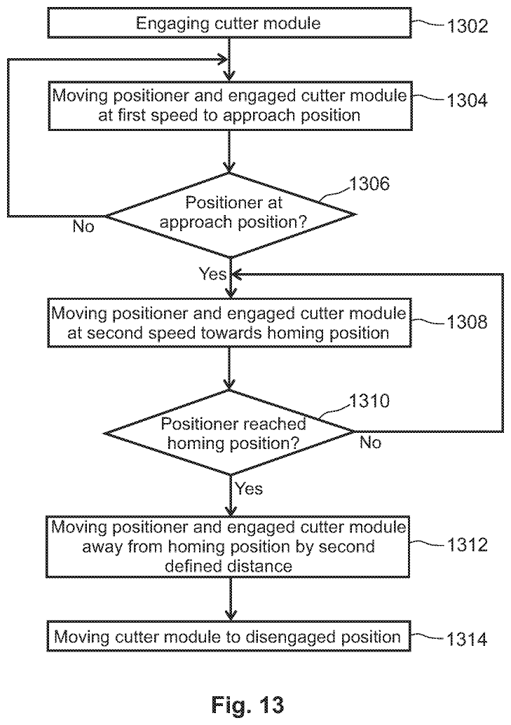

FIG. 13 shows a flow diagram illustrating part of the homing process, according to an example, which may be performed after alignment of the cutter module 20 and its associated positioner 68, such as at 1006 or 1120. Also this example is described with reference to the right hand cutter module 20 and the associated positioner 68 wherein the homing position is located at the right of the print zone and the movement of the positioner 6o away from the homing position and towards the obstacle is from right to left. It may be applied to the left hand cutter module 10 and its associated positioner 58 in an analogous way.

At 1302, the positioner 68 and the aligned cutter module 20 are engaged by a downwards movement of the cutter module. The funnel shape of the mount 64 allows compensating for tolerances of different cutter modules or slight offsets. The inclined interior sides of the mount 64 guide the cutter module to be centered in the mount. In a variant, engaging and disengaging the positioner 68 and the cutter module 20 can be repeated a few times, such as 3 times, to ensure that the cutter module 20 is reliably engaged with the positioner 68. At this point, the position of the positioner 68 and engaged cutter module 20 is known but the positioner is not localized with high precision. The reason is that, when the cutter module hits the obstacle, due to a small deformation or variation between obstacles, the position may be known to be at the obstacle but with a tolerance of a few millimeters, such as +/−₃ mm, for example.

Accordingly, at 1304, the positioner 68 and the engaged cutter module 20 are moved towards the homing position up to a defined approach position, in the drawings from left to right, at a first speed. The approach position may be defined as a position having a defined small distance to the homing position, such as a distance of about 1 cm away from the homing position. The distance may be sufficient to accommodate the positioning tolerance, addressed above. The approach position may be reached by the positioner with low precision, controlling the drive motor to drive the pulley drive and hence move the positioner across a defined distance from the previously known position at the obstacle to the defined approach position. At 1306 it is determined whether the positioner has reached the approach position. As long as the positioner has not reached the approach position, movement towards the homing position continues, at 1304.

The movement towards the approach position at the first speed may be a movement across a substantial distance along the length of the shaft 30. Therefore, selecting a higher speed may decrease the overall time of the homing procedure. However, if the positioner would not stop at the approach position but continue up to the homing position at this high speed, a relatively high deceleration may lengthen the elastic pulley belt and introduce some further inaccuracy in the positioning of the cutter module. Moreover, this could increase wear of the components of the cutter arrangement involved in the movement. Therefore, in the approach phase, the positioner is moved close to the homing position but is stopped at a distance from the homing position sufficiently large to cover the positioning tolerance. A.

At 1308, the positioner 68 and the engaged cutter module 20 are moved further towards the homing position, at a second lower speed, and it is monitored whether the positioner has reached the homing position, at 1310. As long as the positioner has not reached the homing position, movement towards the homing position continues. The fact that the positioner has reached the homing position may be detected via an increase of torque of the drive motor because the homing position may be defined by an end stop which the positioner moves against. An increase of torque, motor current or motor voltage of the drive motor, for example, may be used as a feedback signal to indicate that the homing position has been reached. The second speed may be lower than the first speed so that the low-speed movement of the positioner towards the homing position, at 1308, introduces no or no substantial bias in the transport system and increases positioning accuracy. Positioning the positioner at the second speed achieves good position accuracy and avoids high speed wear of the components involved. For example, the second speed may be about one tenth of the first speed.

At 1312, the positioner and the engaged cutter module 68 can be moved away from the homing position by a second defined distance to place the cutter module to a defined reference position. The second defined distance may be small, such as a few millimeters, but may be sufficient to overcome any backlash in the transmission group and to remove any bias in the pulley drive. In the reference position, and 1314, the cutter module may be moved upwards to its disengaging position to place the cutter module in a defined home position where it can rest until it is to be used for subsequent cutting process.

The procedures described above can be combined. For example, any one of the processes described with reference to FIGS. 12 and 13 can be combined with any one of the processes described with reference to FIG. 10 and ii. Further variations can be provided for. For example, the position at which the cutter module hits an obstacle can be used as a reference position along the length of the shaft and, in this position, the cutter module can be placed in the disengaging (upwards) position until it is picked up and positioned for a subsequent cutting operation. In another example, after hitting the obstacle, the cutter module can be engaged with the positioner and can be moved to a defined reference position, such as a homing position or a position having a defined distance to the homing position. Engagement of the cutter module and its associated positioner may include repeating few times, such as 3 times, engaging and disengaging the positioner 68 and the cutter module 20 to ensure that the cutter module 20 is reliably engaged with the positioner 68.

In a variant, when the positioner is moved first to the homing position, such as at 1104, the positioner can be moved repeatedly to the right and left, such as two or three times, to ensure that movement of the positioner is not blocked. Blocking of the positioner may be recognized from a feedback signal of the drive motor. If blocking of the positioner is detected, an alarm message can be output to a user, such as on a printer display.

A homing position may be defined by an end stop associated with a frame or chassis of the printer or by an end stop ring or protrusion located on the shaft, for example. The end stop or protrusion may be located in such a way that it blocks movement of the positioner. As explained above, the obstacle used during the homing position may be a retractable rib but also may be an end stop at the frame or chassis of the printer or an end stop ring or protrusion located on the shaft.

Drive of the print media advance system (not shown), the shaft 30 and pulley drives 12, 22 and of the cutter modules 10, 20 as well as other entities of the printer and an associated cutting equipment may be controlled by a controller (not shown). The controller can be a microcontroller, ASIC, or other control device, including control devices operating based on hardware or a combination of hardware and software. It can include an integrated memory or communicate with an external memory or both. The same controller or separate controllers may be provided for controlling carriage movement, media advance and the rotary actuator. Different parts of the controller may be located internally or externally to a printer or separate cutting device, in a concentrated or distributed environment.

What is claimed is:

1. A method including
placing a cutter module in an engaging position;
moving a positioner associated with the cutter module away from a homing position to contact and drag the cutter module until it is detected that the cutter module hits a first obstacle; and
aligning the cutter module with the positioner;
wherein, in the engaging position, the cutter module is in the movement path of the positioner.

2. The method of claim 1, further including, before placing the cutter module in the engaging position:
placing the cutter module in a disengaging position;
moving the positioner to a homing position;
moving the cutter module to the engaging position;
moving the positioner away from the homing position;
moving the cutter module to the disengaging position; and
moving the positioner towards the homing position;
wherein, in the disengaging position, the cutter module is clear of the movement path of the positioner.

3. The method of claim 1, further including, after aligning the cutter module with the positioner:
engaging the cutter module with the positioner; and
moving the positioner and the engaged cutter module to the homing position.

4. The method of claim 2 wherein moving the cutter module to the disengaging position comprises an upwards movement and moving the cutter module to the engaging position comprises a downwards movement.

5. The method of claim 4, wherein moving the positioner comprises moving the positioner along a horizontal scanning direction, perpendicular to the upwards and downwards movement.

6. The method of claim 1, wherein detecting that the cutter module hits the first obstacle includes detecting an increase of torque in a drive system of the positioner.

7. The method of claim 1, wherein aligning the cutter module with the positioner further comprises:
after detecting that the cutter module hits the first obstacle, moving the positioner towards the homing position by a defined distance;
moving the cutter module to the disengaging position;
moving the positioner away from the homing position to an engagement position aligned with the cutter module.

8. The method of claim 3, wherein moving the positioner and the engaged cutter module to the homing position further comprises
moving the positioner and the engaged cutter module at a first speed towards the homing position until it is detected that the positioner has reached the homing position;
moving the positioner and the engaged cutter module away from the homing position by a first defined distance;
moving the positioner and the engaged cutter module at a second speed towards the homing position until it is detected that the positioner has reached the homing position;
wherein the second speed is lower than the first speed.

9. The method of claim 8, further comprising:
after moving the positioner and the engaged cutter module at the second speed towards the homing position and after it is detected that the positioner has reached the homing position, moving the positioner and the engaged cutter module away from the homing position by a second defined distance and moving the cutter module to the disengaged position to place the cutter module in a defined home position.

10. A cutter arrangement for a printer, the cutter arrangement including at least one cutter module slidably arranged on a shaft, the shaft extending in a direction perpendicular to a media advance direction of the printer, wherein the cutter module is movable between an engaging position and a disengaging position by respective downwards and upwards movements of the cutter module;
a positioner associated with the cutter module, the cutter module to be engaged and disengaged with the positioner;
a drive to translate and position the positioner along the shaft;
the cutter module, when engaged with the positioner, following the movement of the positioner.

11. The cutter arrangement of claim 10, further including
a controller to control movement of the cutter module and the positioner to place the cutter module in the engaging position;
move the positioner away from a homing position to contact and drag the cutter module until it is detected that the cutter module hits a first obstacle;
engage the cutter module with the positioner; and
move the positioner and the engaged cutter module to the homing position;
wherein, in the engaging position, the cutter module is in the movement path of the positioner and, in the disengaging position, the cutter module is clear of the movement path of the positioner.

12. The cutter arrangement of claim 10, wherein the first obstacle is one of:
a protrusion arranged along the length of the shaft;
a retractable support element to support a print medium; and
an end stop arranged at a distal end of the shaft or at an edge of the print zone.

13. The cutter arrangement of claim 10, wherein the first obstacle is a retractable support element, and the positioner comprises an engaging element to engage the support element and to move the support element from a protruding configuration towards a retracted configuration.

14. The cutter arrangement of claim 13, wherein the engaging element of the positioner comprises an inclined surface to engage a protruding portion of the support element, the inclined surface being tilted with respect to the direction of movement of the support element to move the support element towards the retracted configuration when the inclined plane engages the support element.

15. A printer comprising:
a cutter module to cut a printable medium;
a positioner to move the cutter module in a scanning direction; and
a print medium support including:
a support element to support a print medium while being cut by the cutter module, the support element being movable between a protruding configuration to support the print medium, and a retracted configuration in which the support element is at least partially retracted in a first direction;
wherein the positioner comprise a first engaging element to engage with the cutter module,
wherein the positioner comprises a second engaging element to engage the support element and to move the support element from the protruding configuration towards the retracted configuration as the positioner moves relative to the support element; and
wherein
if the cutter module is engaged with the second engaging element and is moved by the positioner, the first engaging element of the positioner engages with the support element and moves the support element from the protruding configuration towards the retracted configuration; and
if the cutter module is not engaged with the second engaging element and is moved by the positioner, the first engaging element of the positioner does not engage with the support element and the support element will remain in the protruding configuration and present an obstacle to the movement of the cutter module.
